(19) United States
(12) Patent Application Publication
(10) Pub. No.: US 2025/0137403 A1
(43) Pub. Date: May 1, 2025

(54) A GAS TURBINE POWER GENERATION PLANT AND A METHOD FOR REGULATING A PHYSICAL QUANTITY ASSOCIATED THEREWITH

(71) Applicant: Phoenix Biopower IP Services AB, Stockholm (SE)

(72) Inventors: Michael Bartlett, Ekerö (SE); Jens Pålsson, Limhamn (SE); Felix Matthias Güthe, Basel (CH)

(73) Assignee: Phoenix Biopower IP Services AB, Stockholm (SE)

(21) Appl. No.: 18/684,123

(22) PCT Filed: Jul. 14, 2022
(86) PCT No.: PCT/SE2022/050711

§ 371 Date: Feb. 15, 2024

(30) Foreign Application Priority Data
Aug. 19, 2021 (SE) 2151005-2

(51) Int. Cl. F02C 3/30; F02C 3/28; F02C 7/143

(52) U.S. Cl. CPC F02C 3/30; F02C 3/28; F02C 7/1435

(57) ABSTRACT

A gas turbine power generation plant (100; 200; 300; 400; 500; 600) comprising: a gasifier (102) for producing a fuel gas stream (104); a treatment arrangement (110) for treating the fuel gas of the fuel gas stream (104); a combustor (114) for receiving the treated fuel gas stream (116) and for producing a flue gas stream (118); a gas expander unit (120) for receiving the flue gas stream (118), the gas expander unit (120) being configured to be coupled to an electric generator (122); a compressor unit (126a, 126b) for supplying air to one or more of the combustor (114), solid fuel gasifier (102) and gas expander unit (120), one or more of the combustor (114), solid fuel gasifier (102) and gas expander unit (120) being configured to receive an air stream (130) from the compressor unit (126a, 126b); a sensor (134a, 134b, 134c, 134d, 134e, 134f, 134g, 134h, 134i, 134j, 134k) for determining a value of a varying physical quantity; a water fluid injector unit (136a, 136b) for injecting water fluid into one or more of the air stream (130) and the fuel gas stream (104, 116); and a control arrangement (138) for regulating the varying physical quantity. The control arrangement (138) is configured to control the rate of the water fluid injection of the water fluid injector unit (136a, 136b) to regulate the varying physical quantity to a target based on the value of the varying physical quantity.

### TECHNICAL FIELD

Aspects of the present invention relate to a gas turbine power generation plant comprising a solid fuel gasifier for producing a fuel gas stream. Further, aspects of the present invention relate to a method for regulating a varying physical quantity of such a gas turbine power generation plant.

### BACKGROUND

In general, a solid fuel, or fluidized bed, gasifier performs gasification of a solid fuel, for example biomass, and produces or generates a product gas, which may be provided to a combustor of a power generation plant, for example a combustor of a gas turbine power generation plant, possibly via a product gas treatment arrangement of said plant. The product gas may also be called fuel gas, or syngas. In general, the combustor produces a flue gas which is provided to a gas expander unit of said plant. The gas expander unit may in turn be mechanically coupled to an electric generator, which generates electric power.

### SUMMARY

The inventors of the present invention have identified that conventional processes of power generation by way of a gas turbine power generation plant including a solid fuel gasifier are not efficient enough and can be further improved.

An object of embodiments of the invention is to provide a solution which mitigates or solves the drawbacks and problems of conventional solutions.

The above and further objects are solved by the subject matter of the independent claims. Further advantageous embodiments of the invention can be found in the dependent claims.

According to a first aspect of the invention, the above-mentioned and other objects are achieved with a gas turbine power generation plant comprising
a solid fuel gasifier for producing a fuel gas stream,
a fuel gas treatment arrangement for treating the fuel gas of the fuel gas stream,
a combustor for receiving the treated fuel gas stream and for producing a flue gas stream,
a gas expander unit for receiving the flue gas stream, the gas expander unit being configured to be mechanically coupled to an electric generator, and
a compressor unit for supplying air to one or more of the combustor, solid fuel gasifier and gas expander unit,
wherein the compressor unit has an air inlet,
wherein one or more of the combustor, solid fuel gasifier and gas expander unit is/are configured to receive an air stream from the compressor unit,
wherein the gas turbine power generation plant further comprises
one or more sensors for determining a value of a varying physical quantity of the gas turbine power generation plant,
one or more water fluid injector units for injecting water fluid into one or more of the air stream and the fuel gas stream, and
a control arrangement for regulating the varying physical quantity of the gas turbine power generation plant,
wherein the control arrangement is configured to control the rate of the water fluid injection of the one or more water fluid injector units to regulate the varying physical quantity to a target based on the value of the varying physical quantity determined by the sensor.

An advantage of the gas turbine power generation plant according to the first aspect is that the efficiency of the process of power generation by way of a gas turbine power generation plant including a solid fuel gasifier is improved. By the regulation of the varying physical quantity, or the feedback control of the varying physical quantity, introduced by the innovative gas turbine power generation plant and the innovative control arrangement, an improved power generation by way of a gas turbine power generation plant including a solid fuel gasifier is provided. An advantage of the gas turbine power generation plant according to the first aspect is that an improved control and an improved regulation of the electric power output of the gas turbine power generation plant are provided. For example, an advantage of the gas turbine power generation plant according to the first aspect is minimized fluctuations from a desired target, or desired set point. An advantage of the gas turbine power generation plant according to the first aspect is that an improved combustion in the combustor is provided by the water fluid injected by the one or more water fluid injector units. An advantage of the gas turbine power generation plant according to the first aspect is that an improved control of the combustion in the combustor is provided, for example improved flame stability, and/or reduced emissions. An advantage of the gas turbine power generation plant according to the first aspect is that an efficient and improved gas turbine power generation plant is provided.

For some embodiments, the varying physical quantity may be called a variable. For some embodiments, if the value of the varying physical quantity is equal, essentially equal, or corresponds to the target, no change of the rate of the water fluid injection of the one or more water fluid injectors is required or has to be performed, or a change of the rate of the water fluid injection of the one or more water fluid injectors may be left out. Water fluid may comprise or consist of one or more of the group of: water liquid; and water vapour or steam.

According to an advantageous embodiment of the gas turbine power generation plant according to the first aspect, the one or more water fluid injector units comprises/comprise a first water fluid injector unit for injecting water fluid into the fuel gas stream downstream of the solid fuel gasifier and upstream of the combustor,
wherein the control arrangement is configured to control the rate of the water fluid injection of the first water fluid injector unit to regulate the varying physical quantity to the target based on the value of the varying physical quantity determined by the sensor.

An advantage of this embodiment is that the efficiency of the process of power generation by way of a gas turbine power generation plant including a solid fuel gasifier is further improved, and also the amount of power is increased, for example the electric power. An advantage of this embodiment is that an improved combustion in the combustor is provided by way of the water fluid injected by the first water fluid injector unit. An advantage of this embodiment is that an improved control of the combustion in the combustor is provided, for example improved flame stability, and/or reduced emissions. An advantage of this embodiment is that a further improved control and a further improved regulation of the electric power output of the gas turbine power generation plant are provided.

According to a further advantageous embodiment of the gas turbine power generation plant according to the first aspect, the first water fluid injector unit is configured to inject water fluid into the fuel gas stream upstream of the fuel gas treatment arrangement. An advantage of this embodiment is that the treatment of the fuel gas of the fuel gas stream performed by the fuel gas treatment arrangement is improved. For example, supplying water fluid upstream of the fuel gas treatment arrangement makes it possible to control the temperature of the fuel gas treatment arrangement, which is beneficial to perform an efficient treatment of the fuel gas of the fuel gas stream. For some embodiments, it may, for example, be desirable to lower the temperature of the fuel gas and of the fuel gas treatment arrangement, i.e. to provide a cooling effect, by way of the injected water fluid in order to decrease the wear, or avoid damages, of sensitive equipment of the gas treatment arrangement. An advantage of this embodiment is that an improved combustion in the combustor is provided by way of the water fluid injected by the first water fluid injector unit. An advantage of this embodiment is that an improved control of the combustion in the combustor is provided. An advantage of this embodiment is that the efficiency of the power generation by way of a gas turbine power generation plant including a solid fuel gasifier is further improved. An advantage of this embodiment is that a further improved control and a further improved regulation of the electric power output of the gas turbine power generation plant are provided.

According to another advantageous embodiment of the gas turbine power generation plant according to the first aspect, the first water fluid injector unit comprises one or more of the group of:
a first water liquid injector for injecting water liquid into the fuel gas stream downstream of the solid fuel gasifier and upstream of the combustor, wherein the control arrangement is configured to control the rate of the water liquid injection of the first water liquid injector to regulate the varying physical quantity to the target based on the value of the varying physical quantity determined by the sensor; and
a first water vapour injector for injecting water vapour into the fuel gas stream downstream of the solid fuel gasifier and upstream of the combustor, wherein the control arrangement is configured to control the rate of the water vapour injection of the first water vapour injector to regulate the varying physical quantity to the target based on the value of the varying physical quantity determined by the sensor.

An advantage of this embodiment is that the efficiency of the power generation by way of a gas turbine power generation plant including a solid fuel gasifier is further improved. An advantage of this embodiment is that a further improved control and a further improved regulation of the electric power output of the gas turbine power generation plant are provided.

According to yet another advantageous embodiment of the gas turbine power generation plant according to the first aspect, the one or more water fluid injector units comprises/comprise a second water fluid injector unit for injecting water fluid into the air stream downstream of the air inlet of the compressor unit and upstream of one or more of the combustor, solid fuel gasifier and gas expander unit,
wherein the control arrangement is configured to control the rate of the water fluid injection of the second water fluid injector unit to regulate the varying physical quantity to the target based on the value of the varying physical quantity determined by the sensor.

An advantage of this embodiment is that an improved combustion in the combustor is provided by way of the water fluid injected by the second water fluid injector unit. An advantage of this embodiment is that an improved control of the combustion in the combustor is provided. An advantage of this embodiment is that the efficiency of the power generation by way of a gas turbine power generation plant including a solid fuel gasifier is further improved. An advantage of this embodiment is that a further improved control and a further improved regulation of the electric power output of the gas turbine power generation plant are provided.

According to still another advantageous embodiment of the gas turbine power generation plant according to the first aspect, the compressor unit comprises an air outlet,
wherein one or more of the combustor, solid fuel gasifier and gas expander unit is/are configured to receive an air stream from the air outlet of the compressor unit, and
wherein the second water fluid injector unit is configured to inject water fluid into the air stream downstream of the air inlet of the compressor unit and upstream of the air outlet of the compressor unit.

An advantage of this embodiment is that a further improved combustion in the combustor is provided by way of the water fluid injected by the second water fluid injector unit. An advantage of this embodiment is that a further improved control of the combustion in the combustor is provided. An advantage of this embodiment is that the efficiency of the power generation by way of a gas turbine power generation plant including a solid fuel gasifier is further improved. An advantage of this embodiment is that a further improved control and a further improved regulation of the electric power output of the gas turbine power generation plant are provided.

According to an advantageous embodiment of the gas turbine power generation plant according to the first aspect, the compressor unit comprises a low-pressure compressor and a high-pressure compressor,
wherein the second water fluid injector unit is configured to inject water fluid into the air stream between the low-pressure compressor and the high-pressure compressor.

An advantage of this embodiment is that a further improved combustion in the combustor is provided by way of the water fluid injected by the second water fluid injector unit. An advantage of this embodiment is that a further improved control of the combustion in the combustor is provided. An advantage of this embodiment is that the efficiency of the power generation by way of a gas turbine power generation plant including a solid fuel gasifier is further improved. An advantage of this embodiment is that a further improved control and a further improved regulation of the electric power output of the gas turbine power generation plant are provided.

According to a further advantageous embodiment of the gas turbine power generation plant according to the first aspect, the second water fluid injector unit is configured to inject water fluid into the air stream downstream of the low-pressure compressor and upstream of the high-pressure compressor.

An advantage of this embodiment is that a further improved combustion in the combustor is provided by way of the water fluid injected by the second water fluid injector unit. An advantage of this embodiment is that a further improved control of the combustion in the combustor is provided. An advantage of this embodiment is that the efficiency of the power generation by way of a gas turbine power generation plant including a solid fuel gasifier is further improved. An advantage of this embodiment is that a further improved control and a further improved regulation of the electric power output of the gas turbine power generation plant are provided.

According to another advantageous embodiment of the gas turbine power generation plant according to the first aspect, the second water fluid injector unit comprises one or more of the group of:
a second water liquid injector for injecting water liquid into the air stream downstream of the air inlet of the compressor unit and upstream of the air outlet of the compressor unit, wherein the control arrangement is configured to control the rate of the water liquid injection of the second water liquid injector to regulate the varying physical quantity to the target based on the value of the varying physical quantity determined by the sensor; and
a second water vapour injector for injecting water vapour into the air stream downstream of the air inlet of the compressor unit and upstream of the air outlet of the compressor unit, wherein the control arrangement is configured to control the rate of the water vapour injection of the second water vapour injector to regulate the varying physical quantity to the target based on the value of the varying physical quantity determined by the sensor.

An advantage of this embodiment is that the efficiency of the power generation by way of a gas turbine power generation plant including a solid fuel gasifier is further improved. An advantage of this embodiment is that a further improved control and a further improved regulation of the electric power output of the gas turbine power generation plant are provided.

According to yet another advantageous embodiment of the gas turbine power generation plant according to the first aspect, the second water fluid injector unit is configured to inject water fluid into the air stream downstream of the compressor unit and upstream of the combustor. An advantage of this embodiment is that a further improved combustion in the combustor is provided by way of the water fluid injected by the second water fluid injector unit. An advantage of this embodiment is that a further improved control of the combustion in the combustor is provided. An advantage of this embodiment is that the efficiency of the power generation by way of a gas turbine power generation plant including a solid fuel gasifier is further improved. An advantage of this embodiment is that a further improved control and a further improved regulation of the electric power output of the gas turbine power generation plant are provided. For some embodiments, it may be defined that the second water fluid injector unit is configured to inject water fluid into the air stream downstream of an air outlet of the compressor unit and upstream of the combustor.

According to still another advantageous embodiment of the gas turbine power generation plant according to the first aspect, the second water fluid injector unit comprises one or more of the group of:
a third water liquid injector for injecting water liquid into the air stream downstream of the compressor unit and upstream of the combustor, wherein the control arrangement is configured to control the rate of the water liquid injection of the third water liquid injector to regulate the varying physical quantity to the target based on the value of the varying physical quantity determined by the sensor; and
a third water vapour injector for injecting water vapour into the air stream downstream of the compressor unit and upstream of the combustor, wherein the control arrangement is configured to control the rate of the water vapour injection of the third water vapour injector to regulate the varying physical quantity to the target based on the value of the varying physical quantity determined by the sensor.

An advantage of this embodiment is that the efficiency of the power generation by way of a gas turbine power generation plant including a solid fuel gasifier is further improved. An advantage of this embodiment is that a further improved control and a further improved regulation of the electric power output of the gas turbine power generation plant are provided.

According to an advantageous embodiment of the gas turbine power generation plant according to the first aspect, the gas turbine power generation plant comprises a third water fluid injector unit for injecting water fluid into the flue gas stream downstream of the combustor and upstream of the gas expander unit,
wherein the control arrangement is configured to control the rate of the water fluid injection of the third water fluid injector unit to regulate the varying physical quantity to the target based on the value of the varying physical quantity determined by the sensor.

An advantage of this embodiment is that the efficiency of the power generation by way of a gas turbine power generation plant including a solid fuel gasifier is further improved. An advantage of this embodiment is that a further improved control and a further improved regulation of the electric power output of the gas turbine power generation plant are provided.

According to a further advantageous embodiment of the gas turbine power generation plant according to the first aspect, the third water fluid injector unit comprises one or more of the group of:
a fourth water liquid injector for injecting water liquid into the flue gas stream downstream of the combustor and upstream of the gas expander unit, wherein the control arrangement is configured to control the rate of the water liquid injection of the fourth water liquid injector to regulate the varying physical quantity to the target based on the value of the varying physical quantity determined by the sensor; and
a fourth water vapour injector for injecting water vapour into the flue gas stream downstream of the combustor and upstream of the gas expander unit, wherein the control arrangement is configured to control the rate of the water vapour injection of the fourth water vapour injector to regulate the varying physical quantity to the target based on the value of the varying physical quantity determined by the sensor.

An advantage of this embodiment is that the efficiency of the power generation by way of a gas turbine power generation plant including a solid fuel gasifier is further improved. An advantage of this embodiment is that a further improved control and a further improved regulation of the electric power output of the gas turbine power generation plant are provided.

According to another advantageous embodiment of the gas turbine power generation plant according to the first aspect, the varying physical quantity comprises any one of the group of:
a condition of the fuel gas treatment arrangement;
a calorific value of the treated fuel gas of the treated fuel gas stream received by the combustor;
the composition of the treated fuel gas of the treated fuel gas stream received by the combustor;
a combustion condition of the combustor;
a combustion outlet condition of the flue gas of the flue gas stream exiting the combustor;
a combustion inlet condition of the air of the air stream entering the combustor;
a combustion inlet condition of the treated fuel gas of the treated fuel gas stream entering the combustor;
reactivity of the treated fuel gas of the treated fuel gas stream entering the combustor;
H₂ content of the treated fuel gas of the treated fuel gas stream entering the combustor;
a gas expander unit inlet condition of the flue gas of the flue gas stream entering the gas expander unit;
a gas expander unit outlet condition of the flue gas of the flue gas stream exiting the gas expander unit;
a gas expander unit outlet composition of the flue gas of the flue gas stream exiting the gas expander unit;
a power output of the gas expander unit;
an outlet condition of the compressor unit;
a condition of any stage within the compressor unit; and
a condition of any stage within the gas expander unit.

An advantage of this embodiment is that the efficiency of the power generation by way of a gas turbine power generation plant including a solid fuel gasifier is further improved. An advantage of this embodiment is that a further improved control and a further improved regulation of the electric power output of the gas turbine power generation plant are provided.

According to yet another advantageous embodiment of the gas turbine power generation plant according to the first aspect, the condition of the fuel gas treatment arrangement comprises a fuel gas treatment temperature. An advantage of this embodiment is that the efficiency of the power generation by way of a gas turbine power generation plant including a solid fuel gasifier is further improved. An advantage of this embodiment is that a further improved control and a further improved regulation of the electric power output of the gas turbine power generation plant are provided.

According to still another advantageous embodiment of the gas turbine power generation plant according to the first aspect, the combustion condition of the combustor comprises any one of the group of:
combustion temperature;
oxygen content;
an emission content;
CO;
unburned hydrocarbons, UHC;
nitrogen oxides;
a pressure difference between the pressure of the gas of the combustor and the pressure of the treated fuel gas upstream of the combustor; and
flame instability.

An advantage of this embodiment is that the efficiency of the power generation by way of a gas turbine power generation plant including a solid fuel gasifier is further improved. An advantage of this embodiment is that a further improved control and a further improved regulation of the electric power output of the gas turbine power generation plant are provided.

According to an advantageous embodiment of the gas turbine power generation plant according to the first aspect, the combustion outlet condition of the flue gas of the flue gas stream exiting the combustor comprises any one of the group of:
a temperature of the flue gas of the flue gas stream exiting the combustor;
oxygen content of the flue gas of the flue gas stream exiting the combustor;
unburned hydrocarbons, UHC;
nitrogen oxides;
the composition of the flue gas of the flue gas stream exiting the combustor;
CO₂ content of the flue gas of the flue gas stream exiting the combustor;

CO content of the flue gas of the flue gas stream exiting the combustor; and
nitrogen oxides content of the flue gas of the flue gas stream exiting the combustor.

An advantage of this embodiment is that the efficiency of the power generation by way of a gas turbine power generation plant including a solid fuel gasifier is further improved. An advantage of this embodiment is that a further improved control and a further improved regulation of the electric power output of the gas turbine power generation plant are provided.

According to a further advantageous embodiment of the gas turbine power generation plant according to the first aspect, the gas expander unit inlet condition of the flue gas of the flue gas stream entering the gas expander unit comprises any one of the group of:
a temperature of the flue gas of the flue gas stream entering the gas expander unit;
a pressure of the flue gas of the flue gas stream entering the gas expander unit; and
a flow rate of the flue gas of the flue gas stream entering the gas expander unit.

An advantage of this embodiment is that the efficiency of the power generation by way of a gas turbine power generation plant including a solid fuel gasifier is further improved. An advantage of this embodiment is that a further improved control and a further improved regulation of the electric power output of the gas turbine power generation plant are provided.

According to another advantageous embodiment of the gas turbine power generation plant according to the first aspect, the gas expander unit outlet condition of the flue gas of the flue gas stream exiting the gas expander unit comprises any one of the group of:
a temperature of the flue gas of the flue gas stream exiting the gas expander unit;
a pressure of the flue gas of the flue gas stream exiting the gas expander unit;
a flow rate of the flue gas of the flue gas stream exiting the gas expander unit;
the composition of the flue gas of the flue gas stream exiting the gas expander unit;
CO₂ content of the flue gas of the flue gas stream exiting the gas expander unit;
oxygen content of the flue gas of the flue gas stream exiting the gas expander unit;
CO content of the flue gas of the flue gas stream exiting the gas expander unit;
unburned hydrocarbons, UHC; and
nitrogen oxides content of the flue gas of the flue gas stream exiting the gas expander unit.

An advantage of this embodiment is that the efficiency of the power generation by way of a gas turbine power generation plant including a solid fuel gasifier is further improved. An advantage of this embodiment is that a further improved control and a further improved regulation of the electric power output of the gas turbine power generation plant are provided.

According to yet another advantageous embodiment of the gas turbine power generation plant according to the first aspect, the sensor is configured to determine the value of the varying physical quantity by measuring the varying physical quantity.

According to still another advantageous embodiment of the gas turbine power generation plant according to the first aspect, the sensor is configured to determine the value of the varying physical quantity based on one or more other, or second, varying physical quantities measured by one or more of the one or more sensors.

According to a second aspect of the invention, the above mentioned and other objects are achieved with a method for regulating a varying physical quantity of a gas turbine power generation plant, the gas turbine power generation plant comprising
a solid fuel gasifier for producing a fuel gas stream,
a fuel gas treatment arrangement for treating the fuel gas of the fuel gas stream,
a combustor for receiving the treated fuel gas stream and for producing a flue gas stream,
a gas expander unit for receiving the flue gas stream, the gas expander unit being configured to be mechanically coupled to an electric generator, and
a compressor unit for supplying air to one or more of the combustor, solid fuel gasifier and gas expander unit,
wherein the compressor unit has an air inlet,
wherein one or more of the combustor, solid fuel gasifier and gas expander unit is/are configured to receive an air stream from the compressor unit,
wherein the gas turbine power generation plant further comprises
one or more sensors for determining a value of the varying physical quantity of the gas turbine power generation plant, and
one or more water fluid injector units for injecting water fluid into one or more of the air stream and the fuel gas stream,
wherein the method comprises:
determining, by usage of the sensor, a value of the varying physical quantity of the gas turbine power generation plant; and
controlling the rate of the water fluid injection of the one or more water fluid injector units to regulate the varying physical quantity to a target based on the determined value of the varying physical quantity.

Advantages of the method according to the second aspect and its embodiments correspond to the above-or below-mentioned advantages of the gas turbine power generation plant according to the first aspect and its embodiments.

According to an advantageous embodiment of the method according to the second aspect, the one or more water fluid injector units comprises/comprise a first water fluid injector unit for injecting water fluid into the fuel gas stream downstream of the solid fuel gasifier and upstream of the combustor,
wherein the method comprises:
controlling the rate of the water fluid injection of the first water fluid injector unit to regulate the varying physical quantity to the target based on the determined value of the varying physical quantity.

According to a further advantageous embodiment of the method according to the second aspect, the method comprises:
injecting water fluid from the first water fluid injector unit into the fuel gas stream upstream of the fuel gas treatment arrangement.

According to another advantageous embodiment of the method according to the second aspect, the first water fluid injector unit comprises one or more of the group of:
a first water liquid injector for injecting water liquid into the fuel gas stream downstream of the solid fuel gasifier and upstream of the combustor, wherein the method comprises controlling the rate of the water liquid injection of the first water liquid injector to regulate the varying physical quantity to the target based on the determined value of the varying physical quantity; and
a first water vapour injector for injecting water vapour into the fuel gas stream downstream of the solid fuel gasifier and upstream of the combustor, wherein the method comprises controlling the rate of the water vapour injection of the first water vapour injector to regulate the varying physical quantity to the target based on the determined value of the varying physical quantity.

According to yet another advantageous embodiment of the method according to the second aspect, the one or more water fluid injector units comprises/comprise a second water fluid injector unit for injecting water fluid into the air stream downstream of the air inlet of the compressor unit and upstream of one or more of the combustor, solid fuel gasifier and gas expander unit,
wherein the method comprises:
controlling the rate of the water fluid injection of the second water fluid injector unit to regulate the varying physical quantity to the target based on the determined value of the varying physical quantity.

According to still another advantageous embodiment of the method according to the second aspect, the compressor unit comprises an air outlet,
wherein one or more of the combustor, solid fuel gasifier and gas expander unit is/are configured to receive an air stream from the air outlet of the compressor unit,
wherein the method comprises:
injecting water fluid from the second water fluid injector unit into the air stream downstream of the air inlet of the compressor unit and upstream of the air outlet of the compressor unit.

According to an advantageous embodiment of the method according to the second aspect, the compressor unit comprises a low-pressure compressor and a high-pressure compressor,
wherein the method comprises:
injecting water fluid from the second water fluid injector unit into the air stream between the low-pressure compressor and the high-pressure compressor.

According to a further advantageous embodiment of the method according to the second aspect, the method comprises:
injecting water fluid from the second water fluid injector unit into the air stream downstream of the low-pressure compressor and upstream of the high-pressure compressor.

According to another advantageous embodiment of the method according to the second aspect, the second water fluid injector unit comprises one or more of the group of:
a second water liquid injector for injecting water liquid into the air stream downstream of the air inlet of the compressor unit and upstream of the air outlet of the compressor unit, wherein the method comprises controlling the rate of the water liquid injection of the second water liquid injector to regulate the varying physical quantity to the target based on the determined value of the varying physical quantity; and
a second water vapour injector for injecting water vapour into the air stream downstream of the air inlet of the compressor unit and upstream of the air outlet of the compressor unit, wherein the method comprises controlling the rate of the water vapour injection of the second water vapour injector to regulate the varying physical quantity to the target based on the determined value of the varying physical quantity.

According to still another advantageous embodiment of the method according to the second aspect, the method comprises:
injecting water fluid from the second water fluid injector unit into the air stream downstream of the compressor unit and upstream of the combustor. For some embodiments, the method may comprise injecting water fluid from the second water fluid injector unit into the air stream downstream of an air outlet of the compressor unit and upstream of the combustor.

According to yet another advantageous embodiment of the method according to the second aspect, the second water fluid injector unit comprises one or more of the group of:
a third water liquid injector for injecting water liquid into the air stream downstream of the compressor unit and upstream of the combustor, wherein the method comprises controlling the rate of the water liquid injection of the third water liquid injector to regulate the varying physical quantity to the target based on the determined value of the varying physical quantity; and
a third water vapour injector for injecting water vapour into the air stream downstream of the compressor unit and upstream of the combustor, wherein the method comprises controlling the rate of the water vapour injection of the third water vapour injector to regulate the varying physical quantity to the target based on the determined value of the varying physical quantity.

According to an advantageous embodiment of the method according to the second aspect, the gas turbine power generation plant comprises a third water fluid injector unit for injecting water fluid into the flue gas stream downstream of the combustor and upstream of the gas expander unit,
wherein the method comprises:
controlling the rate of the water fluid injection of the third water fluid injector unit to regulate the varying physical quantity to the target based on the value of the varying physical quantity determined by the sensor.

According to a further advantageous embodiment of the method according to the second aspect, the third water fluid injector unit comprises one or more of the group of:
a fourth water liquid injector for injecting water liquid into the flue gas stream downstream of the combustor and upstream of the gas expander unit, wherein the method comprises controlling the rate of the water liquid injection of the fourth water liquid injector to regulate the varying physical quantity to the target based on the determined value of the varying physical quantity; and
a fourth water vapour injector for injecting water vapour into the flue gas stream downstream of the combustor and upstream of the gas expander unit, wherein the method comprises controlling the rate of the water vapour injection of the fourth water vapour injector to regulate the varying physical quantity to the target based on the determined value of the varying physical quantity.

According to another advantageous embodiment of the method according to the second aspect, the varying physical quantity comprises any one of the group of:
a condition of the fuel gas treatment arrangement;
a calorific value of the treated fuel gas of the treated fuel gas stream received by the combustor;
the composition of the treated fuel gas of the treated fuel gas stream received by the combustor;
a combustion condition of the combustor;
a combustion outlet condition of the flue gas of the flue gas stream exiting the combustor;
a combustion inlet condition of the air of the air stream entering the combustor;
a combustion inlet condition of the treated fuel gas of the treated fuel gas stream entering the combustor;
reactivity of the treated fuel gas of the treated fuel gas stream entering the combustor;
H₂ content of the treated fuel gas of the treated fuel gas stream entering the combustor;
a gas expander unit inlet condition of the flue gas of the flue gas stream entering the gas expander unit;
a gas expander unit outlet condition of the flue gas of the flue gas stream exiting the gas expander unit;
a gas expander unit outlet composition of the flue gas of the flue gas stream exiting the gas expander unit;
a power output of the gas expander unit;
an outlet condition of the compressor unit;
a condition of any stage within the compressor unit; and
a condition of any stage within the gas expander unit.

According to yet another advantageous embodiment of the method according to the second aspect, the condition of the fuel gas treatment arrangement comprises a fuel gas treatment temperature.

According to still another advantageous embodiment of the method according to the second aspect, the combustion condition of the combustor comprises any one of the group of:
combustion temperature;
oxygen content;
an emission content;
CO;
unburned hydrocarbons, UHC;
nitrogen oxides;
a pressure difference between the pressure of the gas of the combustor and the pressure of the treated fuel gas upstream of the combustor; and
flame instability.

According to an advantageous embodiment of the method according to the second aspect, the combustion outlet condition of the flue gas of the flue gas stream exiting the combustor comprises any one of the group of:
a temperature of the flue gas of the flue gas stream exiting the combustor;
oxygen content of the flue gas of the flue gas stream exiting the combustor;
unburned hydrocarbons, UHC;
nitrogen oxides;
the composition of the flue gas of the flue gas stream exiting the combustor;
CO₂ content of the flue gas of the flue gas stream exiting the combustor;
CO content of the flue gas of the flue gas stream exiting the combustor; and nitrogen oxides content of the flue gas of the flue gas stream exiting the combustor.

According to a further advantageous embodiment of the method according to the second aspect, the gas expander unit inlet condition of the flue gas of the flue gas stream entering the gas expander unit comprises any one of the group of:
a temperature of the flue gas of the flue gas stream entering the gas expander unit;
a pressure of the flue gas of the flue gas stream entering the gas expander unit; and
a flow rate of the flue gas of the flue gas stream entering the gas expander unit.

According to an advantageous embodiment of the method according to the second aspect, the gas expander unit outlet condition of the flue gas of the flue gas stream exiting the gas expander unit comprises any one of the group of:
a temperature of the flue gas of the flue gas stream exiting the gas expander unit;
a pressure of the flue gas of the flue gas stream exiting the gas expander unit;
a flow rate of the flue gas of the flue gas stream exiting the gas expander unit;
the composition of the flue gas of the flue gas stream exiting the gas expander unit;
CO₂ content of the flue gas of the flue gas stream exiting the gas expander unit;
oxygen content of the flue gas of the flue gas stream exiting the gas expander unit;
CO content of the flue gas of the flue gas stream exiting the gas expander unit;
unburned hydrocarbons, UHC; and
nitrogen oxides content of the flue gas of the flue gas stream exiting the gas expander unit.

According to a further advantageous embodiment of the method according to the second aspect, the value of the varying physical quantity is determined by way of the sensor by measuring the varying physical quantity by way of the sensor.

According to still another advantageous embodiment of the method according to the second aspect, the value of the varying physical quantity is determined by way of the sensor based on one or more other, or second, varying physical quantities measured by the sensor.

The above-mentioned features and embodiments of the gas turbine power generation plant and the method, respectively, may be combined in various possible ways providing further advantageous embodiments.

Further advantageous embodiments of the gas turbine power generation plant and the method according to the present invention and further advantages with the embodiments of the present invention emerge from the detailed description of embodiments.

### BRIEF DESCRIPTION OF THE DRAWINGS

Embodiments of the invention will now be illustrated, for exemplary purposes, in more detail by way of embodiments and with reference to the enclosed drawings, where similar references are used for similar parts, in which:

FIG. 1A is a schematic diagram illustrating of a first embodiment of the gas turbine power generation plant according to the first aspect of the invention;

FIG. 1B is a schematic diagram illustrating of another embodiment of the gas turbine power generation plant according to the first aspect of the invention;

FIG. 2 is a schematic sectional side view of a version of the compressor unit of a second embodiment of the gas turbine power generation plant according to the first aspect of the invention;

FIG. 3 is a schematic diagram illustrating various locations of the one or more sensors of embodiments of the gas turbine power generation plant according to the first aspect of the invention;

FIG. 4 is a schematic diagram illustrating of a third embodiment of the gas turbine power generation plant according to the first aspect of the invention;

FIG. 5 is a schematic diagram illustrating of a fourth embodiment of the gas turbine power generation plant according to the first aspect of the invention;

FIG. 6 is a schematic diagram illustrating of a fifth embodiment of the gas turbine power generation plant according to the first aspect of the invention;

FIG. 7 is a schematic flow chart illustrating aspects of embodiments of the method according to the second aspect of the invention; and

FIG. 8 is a schematic view illustrating a version of the control arrangement of embodiments of the gas turbine power generation plant according to the first aspect of the invention, in which a method according to any one of the herein described embodiments may be implemented;

### DETAILED DESCRIPTION

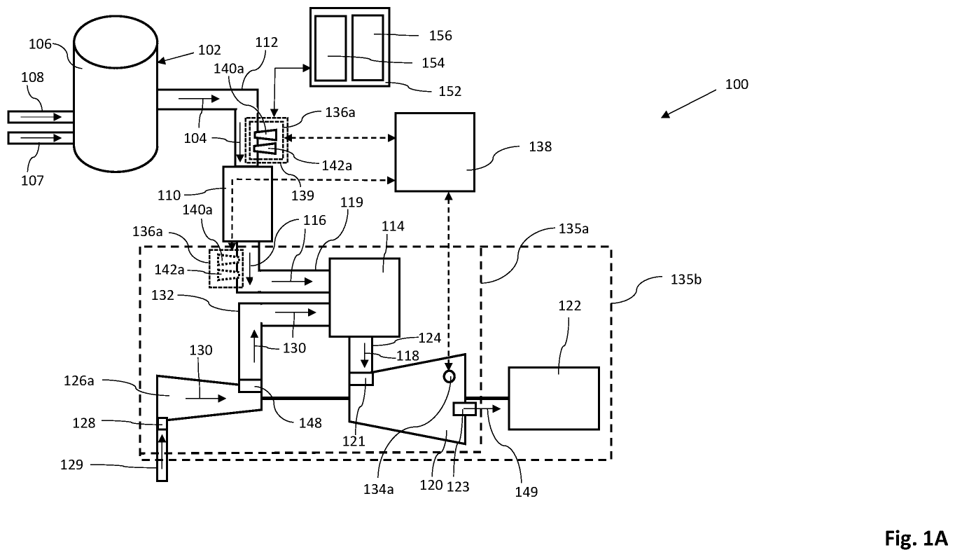

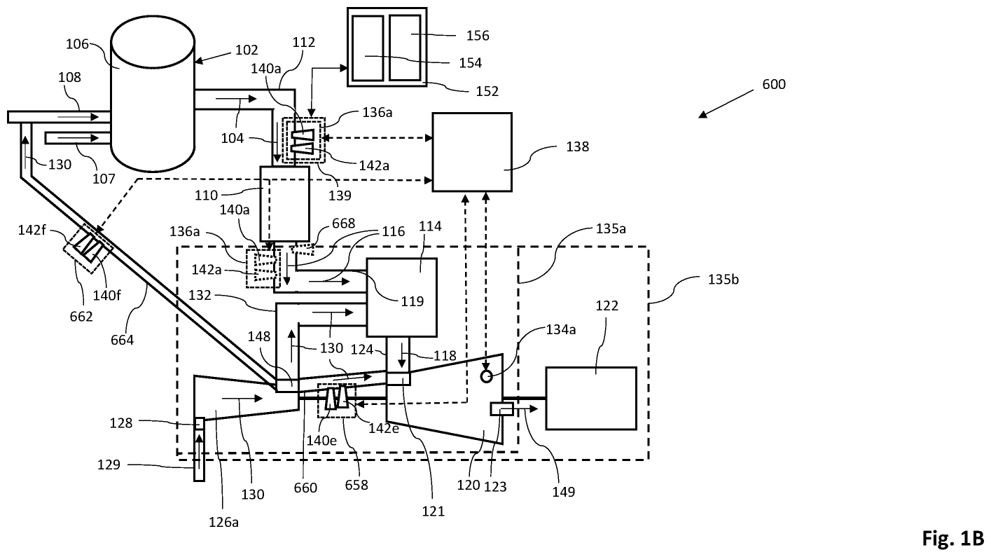

With reference to FIG. 1A, a first embodiment of the gas turbine power generation plant 100 according to the first aspect of the invention is schematically illustrated. The gas turbine power generation plant 100 includes a solid fuel gasifier 102 for producing a fuel gas stream 104. The solid fuel may be a solid carbon fuel, for example biomass, peat, wood, energy crop, wastes, coal etc. However, other solid fuels are possible. It may be described that a gasification of the solid fuel is performed in the solid fuel gasifier 102. For some embodiments, the solid fuel gasifier 102 may be referred to as a fluidized bed gasifier 102. For some embodiments, the solid fuel gasifier 102 may be called a reactor. The solid fuel gasifier 102 may include a vessel 106. For some embodiments, the vessel 106 may have a tubular shape, for example a circular tubular shape, but other shapes or possible. The vessel 106 may be made of a suitable metal material, or any other suitable material. The vessel 106 may comprise one or more refractory and/or insulation layers, which for example may be located inside of a tubular metal wall of the vessel 106. The solid fuel gasifier 102, or the vessel 106, may be described to contain a turbulent, or bubbling, or circulating, fluidized bed. The fluidized bed may comprise a solid fuel and solid fuel particles to which a gasification medium, for example including one or more of: H₂O, air, O₂, N₂ and steam, is added. The solid fuel particles may be solid carbon fuel particles. For some embodiments, the solid fuel gasifier 102 is pressurised to about 30 to 60 bar. For some embodiments, the temperature of the fuel gas stream 104 leaving the solid fuel gasifier 102 may be at least 800 degrees Celsius.

With reference to FIG. 1A, the gas turbine power generation plant 100 may include a solid fuel, or raw fuel, inlet conduit 107. The solid fuel gasifier 102 may be configured to receive solid fuel via the solid fuel inlet conduit 107. The gas turbine power generation plant 100 may include a gasification medium inlet conduit 108. The solid fuel gasifier 102 may be configured to receive the gasification medium via the gasification medium inlet conduit 108.

With reference to FIG. 1A, the gas turbine power generation plant 100 includes a fuel gas treatment arrangement 110 for treating the fuel gas of the fuel gas stream 104 from the solid fuel gasifier 102. The fuel gas treatment arrangement 110 may be connected to the solid fuel gasifier 102 via a conduit 112. When an item is disclosed to be connected to another item in this disclosure, in general it implies that the two items are fluidly connected to one another. It may be defined that the fuel gas treatment arrangement 110 is arranged downstream of the solid fuel gasifier 102. For some embodiments, the fuel gas treatment arrangement 110 may include a fuel gas clean-up device, wherein, inter alia, unwanted impurities are removed from the fuel gas stream 104. For example, for some embodiments, the fuel gas treatment arrangement 110 may include one or more filters or filtering steps.

However, it is to be understood that the fuel gas treatment arrangement 110 may include other or additional fuel gas treatment equipment or units.

With reference to FIG. 1A, the gas turbine power generation plant 100 includes a combustor 114 for receiving the treated fuel gas stream 116 from the fuel gas treatment arrangement 110 and for producing a flue gas stream 118. Thus, the combustor 114 is configured to produce a flue gas stream 118. It may be defined that the combustor 114 is configured to combust fuel gas of the treated fuel gas stream 116. Thus, fuel gas of the treated fuel gas stream 116 is combusted in the combustor 114, for example together with oxygen supplied by a compressor unit 126a disclosed below. The combustor 114 may be connected to the fuel gas treatment arrangement 110 via a conduit 119. It may be defined that the combustor 114 is arranged downstream of the fuel gas treatment arrangement 110. It may be defined that the combustor 114 is arranged downstream of the solid fuel gasifier 102. The flue gas of the flue gas stream 118 exiting the combustor 114 may have 30-60% volume water vapour. However, other % volumes are possible.

With reference to FIG. 1A, the gas turbine power generation plant 100 includes a gas expander unit 120 for receiving the flue gas stream 118. For some embodiments, the gas expander unit 120 may be referred to as a gas expander. The gas expander unit 120 is configured to be mechanically coupled to an electric generator 122. The electric generator 122 may be described to generate, or produce, electric power or energy, or convert motive power into electric power. It may be defined that the electric generator 122 is configured to generate electric power from mechanical movement, or mechanical energy, of the gas expander unit 120. For some embodiments, the gas expander unit 120 may be connected to the combustor 114 via a conduit 124. It may be defined that the gas expander unit 120 is arranged downstream of the combustor 114. It may be defined that the gas expander unit 120 is arranged downstream of the fuel gas treatment arrangement 110. It may be defined that the gas expander unit 120 is arranged downstream of the solid fuel gasifier 102. It may be defined that the gas expander unit 120 is configured to receive the flue gas stream 118. It may be defined that the gas expander unit 120 comprises an inlet 121 for the flue gas stream 118, or an inlet 121 for receiving the flue gas stream 118. It may be defined that the gas expander unit 120 comprises an outlet 123.

It may be defined that the electric generator 122 includes a stator and a rotor rotatable about an axis of rotation in relation to the stator. The gas expander unit 120 may be described to comprise a rotatable member rotatable by the output of the combustor 114. The rotatable member of the gas expander unit 120 may be described to be configured to rotate the rotor of the electric generator 122.

With reference to FIG. 1A, the gas turbine power generation plant 100 includes a compressor unit 126a for supplying air to one or more of the combustor 114, solid fuel gasifier 102 and gas expander unit 120. Thus, the compressor unit 126a may be configured to supply air to the combustor 114 and/or the solid fuel gasifier 102 and/or the gas expander unit 120. In the embodiment illustrated in FIG. 1A, the compressor unit 126a is configured to supply air to the combustor 114. Air includes oxygen. The compressor unit 126a includes an air inlet 128 for the inlet of air. The gas turbine power generation plant 100 may include an air inlet conduit 129 connected to the air inlet 128. It may be defined that the air inlet 128 is located downstream of the inlet conduit 129. The compressor unit 126a may be configured to receive air via the air inlet 128 and/or the air inlet conduit 129. One or more of the combustor 114, solid fuel gasifier 102 and gas expander unit 120 is/are configured to receive an air stream 130 from the compressor unit 126a. Thus, the combustor 114 and/or the solid fuel gasifier 102 and/or the gas expander unit 120 is/are configured to receive an air stream 130 from the compressor unit 126a. In the embodiment illustrated in FIG. 1A, the combustor 114 is configured to receive an air stream 130 from the compressor unit 126a. For some embodiments, the compressor unit 126a may be referred to as a compressor. For some embodiments, the combustor 114 may be connected to the compressor unit 126a via a conduit 132. It may be defined that the combustor 114 is arranged downstream of the compressor unit 126a. For some embodiments, the gas expander unit 120 may be mechanically coupled to the compressor unit 126a, for example to transfer motive power to the compressor unit 126a. The compressor unit 126a may be defined to be configured for the compression of air. The compressor unit 126a may be described to comprise a rotatable member. The rotatable member of the gas expander unit 120 may be described to be configured to rotate the rotatable member of the compressor unit 126a, for example to compress the air.

With reference to FIG. 1A, the gas turbine power generation plant 100 includes one or more sensors 134a for determining a value of a varying physical quantity of the gas turbine power generation plant 100. The varying physical quantity may be referred to as a variable. For some embodiments, the sensor 134a is configured to determine the value of the varying physical quantity by measuring the varying physical quantity. For some embodiments, the sensor 134a is configured to determine the value of the varying physical quantity based on one or more other, or second, varying physical quantities, for example measured by one or more of the other one or more sensors 134a.

With reference to FIG. 1A, for some embodiments, the gas turbine power generation plant 100 may be described to comprise a gas turbine unit 135a, 135b. The gas turbine unit 135a, 135b may comprise the combustor 114, the gas expander unit 120 and the compressor unit 126a. In addition, for some embodiments, the gas turbine unit 135b may be described to comprise the electric generator 122. Thus, it may be described that the gas expander unit 120 is included in, or part of, a gas turbine unit 135a, 135b. It is to be understood that the various features or items of the gas turbine power generation plant 100 in FIG. 1A may be arranged in various ways, for example different from what is schematically illustrated in FIG. 1A. For example, for some embodiments, one or more of the conduits as illustrated may be excluded.

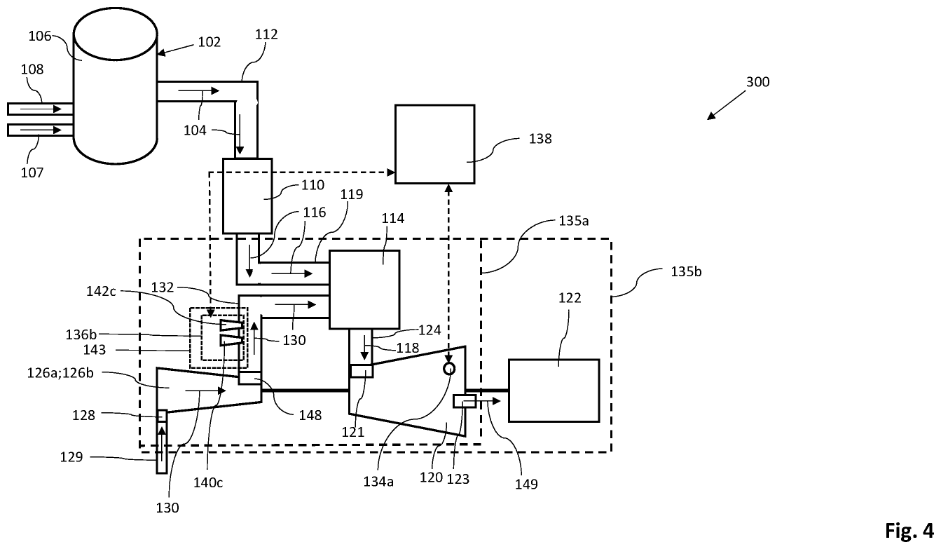

With reference to FIGS. 1A, 1B, 2 and 4, the gas turbine power generation plant 100 includes one or more water fluid injector units 136a, 136b, 658, 662 (see FIGS. 1B, 2 and 4 for water fluid injector units 136b, 658, 662) for injecting water fluid into one or more of the air stream 130, for example upstream of the combustor 114, and fuel gas stream 104, 116, for example upstream of the combustor 114. Thus, with reference to FIG. 4, for example, for some embodiments, the one or more water fluid injector units 136a, 136b, 658, 662 is/are configured to inject water fluid into the air stream 130 from, or of, the compressor unit 126a, for example upstream of the combustor 114. For some embodiments, the one or more water fluid injector units 136a is/are configured to inject water fluid into the fuel gas stream 104, 116 upstream of the combustor 114, for the example into the fuel gas stream 104 upstream of the fuel gas treatment arrangement 110 and/or into the fuel gas stream 116 downstream of the fuel gas treatment arrangement 110. For some embodiments, the one or more water fluid injector units 136a, 136b, 658, 662 is/are configured to inject water fluid into both the air stream 130, for example upstream of the combustor 114, and the fuel gas stream 104, 116, for example upstream of the combustor 114. For some embodiments, each water fluid injector unit 136a, 136b, 658, 662 may comprise one or more water fluid injectors for injecting water fluid. For some embodiments, water fluid injectors of the same water fluid injector unit 136a, 136b, 658, 662 may be spaced apart. For some embodiments, the water fluid injectors of the same water fluid injector unit 136a, 136b, 658, 662 may be formed into one single unit.

Water fluid may comprise or consist of one or more of the group of: water liquid; and water vapour or steam. The water liquid is water in liquid form and may also be called liquefied water or simply water. The water vapour may be called steam. The water liquid or water may be hot when injected. In general, a fluid may comprise or consist of one or more of the group of: a liquid; a gas, such as steam; a gas mixture; and a mixture of a liquid and one or more gases.

With reference to FIG. 1A, the gas turbine power generation plant 100 includes a control arrangement 138 for regulating the varying physical quantity of the gas turbine power generation plant 100. The control arrangement 138 is configured to control the rate of the water fluid injection of the one or more water fluid injector units 136a to regulate the varying physical quantity to a target based on the value of the varying physical quantity determined by the sensor 134a. Expressed alternatively, the control arrangement 138 is configured to control the rate of the water fluid injection of the one or more water fluid injector units 136a based on the value of the varying physical quantity, which is determined by the sensor 134a, in order to regulate the varying physical quantity to a target. For some embodiments, the innovative gas turbine power generation plant 100 and/or the innovative control arrangement 138 may be described to provide a feedback control of the varying physical quantity.

With reference to FIG. 1A, for some embodiments, the above-mentioned target may comprise or consist of any one of a target value, a target range and a target threshold. For some embodiments, the control of the rate of the water fluid injection performed by the control arrangement 138 may include changing the rate of the water fluid injection. For some embodiments, if the value of the varying physical quantity is equal, essentially equal, or corresponds to the target, no change of the rate of the water fluid injection of the one or more water fluid injectors 136a is required or has to be performed by the control arrangement 138, or a change of the rate of the water fluid injection of the one or more water fluid injectors 136a may be left out. For some embodiments, the control arrangement 138 may be configured to regulate a plurality of varying physical quantities of the gas turbine power generation plant 100. For some embodiments, the control arrangement 138 may be configured to regulate each varying physical quantity of the plurality of varying physical quantities to a target based on the value of the varying physical quantity determined by the sensor 134a.

More specifically, in the embodiment illustrated in FIG. 1A, the one or more water fluid injector units 136a may include a first water fluid injector unit 136a for injecting water fluid into the fuel gas stream 104, 116 downstream of the solid fuel gasifier 102 and upstream of the combustor 114, wherein the control arrangement 138 may be configured to control the rate of the water fluid injection of the first water fluid injector unit 136a to regulate the varying physical quantity to the target based on the value of the varying physical quantity determined by the sensor 134a. Even more specifically, in the embodiment illustrated in FIG. 1A, the first water fluid injector unit 136a is configured to inject water fluid into the fuel gas stream 104 upstream of the fuel gas treatment arrangement 110. For some embodiments, it may, for example, be desirable to lower the temperature of the fuel gas upstream of the fuel gas treatment arrangement 110 before the fuel gas enters the fuel gas treatment arrangement 110, i.e. to provide a cooling effect, by way of the first water fluid injector unit 136a in order to decrease the wear, or avoid damages, of sensitive equipment of the gas turbine unit 1351, 135b. For example, the temperature of the fuel gas of the fuel gas stream 104 may be reduced to about 500 degrees Celsius. However, in alternative embodiments, the first water fluid injector unit 136a may be configured to inject water fluid into the fuel gas stream 116 downstream of the fuel gas treatment arrangement 110.

With reference to FIG. 1A, for some embodiments, the gas turbine power generation plant 100 may include a fuel gas, or fuel gas stream, cooler 139. For some embodiments, the first water fluid injector unit 136a may be placed in the fuel gas cooler 139. For some embodiments, the first water fluid injector unit 136a is configured to inject the water fluid in the fuel gas cooler 139 and into the fuel gas stream 104, 116 downstream of the solid fuel gasifier 102 and upstream of the combustor 114. For some embodiments, the fuel gas cooler 139 may be located upstream of the fuel gas treatment arrangement 110.

With reference to FIG. 1A, the first water fluid injector unit 136a may include one or more of the group of:
a first water liquid injector 140a for injecting water liquid into the fuel gas stream 104, 116 downstream of the solid fuel gasifier 102 and upstream of the combustor 114, wherein the control arrangement 138 is configured to control the rate of the water liquid injection of the first water liquid injector 140a to regulate the varying physical quantity to the target based on the value of the varying physical quantity determined by the sensor 134a; and
a first water vapour, or steam, injector 142a for injecting water vapour into the fuel gas stream 104, 116 downstream of the solid fuel gasifier 102 and upstream of the combustor 114, wherein the control arrangement 138 is configured to control the rate of the water vapour injection of the first water vapour injector 142a to regulate the varying physical quantity to the target based on the value of the varying physical quantity determined by the sensor 134a.

With reference to FIG. 1B, another embodiment of the gas turbine power generation plant 600 according to the first aspect of the invention is schematically illustrated. Several features of the gas turbine power generation plant 600 of FIG. 1B may correspond to features of the gas turbine power generation plant 100 of FIG. 1A and are thus not described in further detail here to avoid repetition. The gas turbine power generation plant 600 of FIG. 1B differs from the gas turbine power generation plant 100 of FIG. 1A in that the compressor unit 126a is configured to supply air to the gas expander unit 120, for example by bypassing the combustor 114, and in that the gas expander unit 120 is configured to receive an air stream 130 from the compressor unit 126a, for example directly from the compressor unit 126a, for example by bypassing the combustor 114. Further, the gas turbine power generation plant 600 of FIG. 1B differs from the gas turbine power generation plant 100 of FIG. 1A in that an additional water fluid injector unit 658 is provided, for injecting water fluid into the air stream 130 from the compressor unit 126a to the gas expander unit 120, for example downstream of the compressor unit 126a and upstream of the gas expander unit 120. For some embodiments, the gas expander unit 120 may be connected to the compressor unit 126a via a conduit 660. The additional water fluid injector unit 658 may include one or more of a water liquid injector 140e and a water vapour injector 142e. The control arrangement 138 may be configured to control the rate of the water fluid injection of the water fluid injector unit 658 to regulate the varying physical quantity to a target based on the value of the varying physical quantity determined by a sensor 134a. For example, by way of the additional water fluid injector unit 658, the air stream 130 from the compressor unit 126a directly to the gas expander unit 120 may be cooled, and the gas expander unit 120 may thereby be efficiently cooled, for example the one or more rotatable members, or blades, of the gas expander unit 120. By way of the additional water fluid injector unit 658, the cooling of the gas expander unit 120 is improved, and the temperature and/or cooling of the gas expander unit 120 can be efficiently controlled.

Further, with reference to FIG. 1B, the gas turbine power generation plant 600 of FIG. 1B differs from the gas turbine power generation plant 100 of FIG. 1A in that the compressor unit 126a is configured to supply air to the solid fuel gasifier 102, for example via the gasification medium inlet conduit 108, and in that the solid fuel gasifier 102 is configured to receive an air stream 130 from the compressor unit 126a. Further, the gas turbine power generation plant 600 of FIG. 1B differs from the gas turbine power generation plant 100 of FIG. 1A in that another additional water fluid injector unit 662 is provided, for injecting water fluid into the air stream 130 from the compressor unit 126a to the solid fuel gasifier 102, for example downstream of the compressor unit 126a. For some embodiments, the solid fuel gasifier 102 may be connected to the compressor unit 126a via a conduit 664. The additional water fluid injector unit 662 may include one or more of a water liquid injector 140f and a water vapour injector 142f. The control arrangement 138 may be configured to control the rate of the water fluid injection of the water fluid injector unit 662 to regulate the varying physical quantity to a target based on the value of the varying physical quantity determined by a sensor 134a. For example, by way of the additional water fluid injector unit 662, the air stream 130 from the compressor unit 126a to solid fuel gasifier 102 may be cooled, and properties of the solid fuel in the solid fuel gasifier 102 can be controlled. For example, the temperature of the solid fuel and/or fluidization characteristics of the solid fuel in the solid fuel gasifier 102, for example fluidization characteristics of the fluidized bed of the solid fuel gasifier 102, can be efficiently controlled. By way of the additional water fluid injector unit 662, the cooling of the solid fuel in the solid fuel gasifier 102 is improved. By way of the additional water fluid injector unit 662, the control of properties of the solid fuel in the solid fuel gasifier 102 is improved.

With reference to FIG. 1B, for some embodiments, one of the additional water fluid injector units 658 and 662 may be excluded.

Further, with reference to FIG. 1B, for some embodiments, the gas turbine power generation plant 600 may be configured to inject additional fuel, for example a fluid fuel, for example in liquid form, or in gas form, downstream of the fuel gas treatment arrangement 110 and upstream of the combustor 114, for example upstream of a first water fluid injector unit 136a configured to inject water fluid into the fuel gas stream 116 downstream of the fuel gas treatment arrangement 110 and upstream of the combustor 114. For some embodiments, the gas turbine power generation plant 600 may include a fuel injector 668 for injecting said additional fuel downstream of the fuel gas treatment arrangement 110 and upstream of the combustor 114, for example upstream of a first water fluid injector unit 136a configured to inject water fluid into the fuel gas stream 116 downstream of the fuel gas treatment arrangement 110 and upstream of the combustor 114.

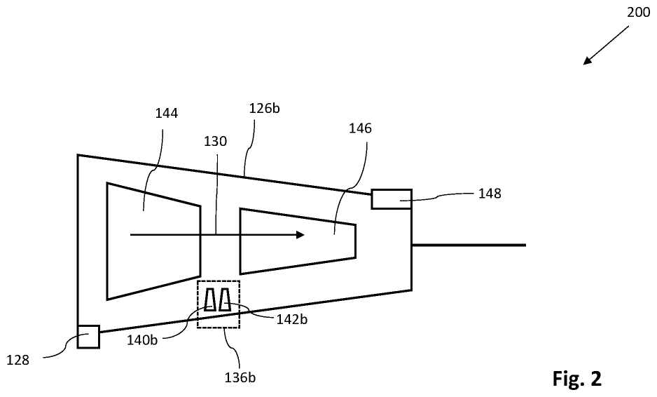

With reference to FIG. 2, a version of the compressor unit 126b of the gas turbine power generation plant 200 and a second embodiment of the gas turbine power generation plant 200 are schematically illustrated. In addition to the compressor unit 126b, features of the second embodiment of the gas turbine power generation plant 200 may correspond to features of the first embodiment of the gas turbine power generation plant 100 illustrated in FIG. 1A and are thus not repeated here. The compressor unit 126b illustrated in FIG. 2 may comprise a low-pressure compressor 144 and a high-pressure compressor 146. For some embodiments, the high-pressure compressor 146 may be located downstream of the low-pressure compressor 144. It is to be understood, that the power generation plant 100 illustrated in FIG. 1A may include a compressor unit 126a without a low-pressure compressor 144 and without a high-pressure compressor 146. It may be defined that one or more of the compressor unit 126a, 126b, the low-pressure compressor 144 and the high-pressure compressor 146 is/are configured to compress air.

With reference to FIG. 2, for some embodiments of the gas turbine power generation plant 200, the one or more water fluid injector units 136a, 136b may include a second water fluid injector unit 136b for injecting water fluid into the air stream 130 downstream of the air inlet 128 of the compressor unit 126b and upstream of the combustor 114, wherein the control arrangement 138 may be configured to control the rate of the water fluid injection of the second water fluid injector unit 136b to regulate the varying physical quantity to the target based on the value of the varying physical quantity determined by the sensor 134a.

With reference to FIG. 2, for some embodiments, the compressor unit 126b includes an air outlet 148 for the outlet of air. The combustor 114 may be configured to receive an air stream 130 from the air outlet 148 of the compressor unit 126b. For some embodiments, the second water fluid injector unit 136b is configured to inject water fluid into the air stream 130 downstream of the air inlet 128 of the compressor unit 126b and upstream of the air outlet 148 of the compressor unit 126b.

With reference to FIG. 2, for some embodiments, the second water fluid injector unit 136b is configured to inject water fluid into the air stream 130 between the low-pressure compressor 144 and the high-pressure compressor 146. For some embodiments, the second water fluid injector unit 136b is configured to inject water fluid into the air stream 130 downstream of the low-pressure compressor 144 and upstream of the high-pressure compressor 146.

With reference to FIG. 2, the second water fluid injector unit 136b may include one or more of the group of:
a second water liquid injector 140b for injecting water liquid into the air stream 130 downstream of the air inlet 128 of the compressor unit 126b and upstream of the air outlet 148 of the compressor unit 126, wherein the control arrangement 138 may be configured to control the rate of the water liquid injection of the second water liquid injector 140b to regulate the varying physical quantity to the target based on the value of the varying physical quantity determined by the sensor 134a; and
a second water vapour, or steam, injector 142b for injecting water vapour into the air stream 130 downstream of the air inlet 128 of the compressor unit 126b and upstream of the air outlet 148 of the compressor unit 126b, wherein the control arrangement 138 may be configured to control the rate of the water vapour injection of the second water vapour injector 142b to regulate the varying physical quantity to the target based on the value of the varying physical quantity determined by the sensor 134a.

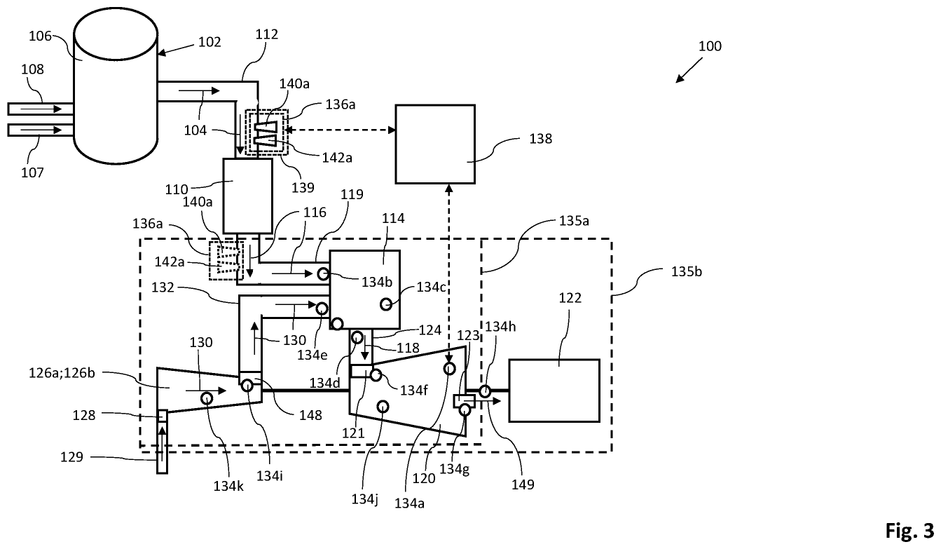

With reference FIG. 3, various versions and locations of the one or more sensors 134a, 134b, 134c, 134d, 134e, 134f, 134g, 134h, 134i, 134j, 134k of embodiments of the gas turbine power generation plant 100, 200, 300, 400, 500 according to the first aspect are schematically illustrated. For example, the one or more sensors 134a, 134b, 134c, 134d, 134e, 134f, 134g, 134h, 134i, 134j, 134k may include one or more of the group of:
a sensor 134a for determining and/or measuring a condition of the fuel gas treatment arrangement 110;
a sensor 134b for determining and/or measuring a calorific value of the treated fuel gas of the treated fuel gas stream 116 received by the combustor 114;
a sensor 134b for determining and/or measuring the composition of the treated fuel gas of the treated fuel gas stream 116 received by the combustor 114;
a sensor 134c for determining and/or measuring a combustion condition of the combustor 114;
a sensor 134d for determining and/or measuring a combustion outlet condition of the flue gas of the flue gas stream 118 exiting the combustor 114;
a sensor 134e for determining and/or measuring a combustion inlet condition of the air of the air stream 130 entering the combustor 114;
a sensor 134b for determining and/or measuring a combustion inlet condition of the treated fuel gas of the treated fuel gas stream 116 entering the combustor 114;
a sensor 134b for determining and/or measuring a reactivity of the treated fuel gas of the treated fuel gas stream 116 entering the combustor 114;
a sensor 134b for determining and/or measuring H₂ content of the treated fuel gas of the treated fuel gas stream 116 entering the combustor 114;
a sensor 134f for determining and/or measuring a gas expander unit inlet condition of the flue gas of the flue gas stream 118 entering the gas expander unit 120;
a sensor 134g for determining and/or measuring a gas expander unit outlet condition of the flue gas of the flue gas stream 149 exiting the gas expander unit 120;
a sensor 134g for determining and/or measuring a gas expander unit outlet composition of the flue gas of the flue gas stream 149 exiting the gas expander unit 120;
a sensor 134h for determining and/or measuring a power output of the gas expander unit 120, for example an electric power output;
a sensor 134i for determining and/or measuring an outlet condition of the compressor unit 126a, 126b;
a sensor 134k for determining and/or measuring a condition of any stage within the compressor unit 126a, 126b; and
a sensor 134j for determining and/or measuring condition of any stage within the gas expander unit 120.

With reference FIG. 3, the one or more sensors 134a, 134b, 134c, 134d, 134e, 134f, 134g, 134h, 134i, 134j, 134k may comprise or consist of one or more of the group of: a temperature sensor; a pressure sensor; a piezoelectric sensor; an optical sensor; an electromagnetic sensor; a gas sensor or gas detector; a flow or flow rate sensor; a flowmeter; an accelerometer; an infrared sensor; and a semiconductor sensor. However, other types of sensors are also possible. It is to be understood that the one or more of the the one or more sensors 134a, 134b, 134c, 134d, 134e, 134f, 134g, 134h, 134i, 134j, 134k illustrated in FIG. 3 and for the first embodiment of the gas turbine power generation plant 100 may apply to other embodiments of the gas turbine power generation plant 200, 300, 400, 500, for example to the embodiments illustrated in FIGS. 2, 4 and 5. For some embodiments, it is to be understood that one or more of the the one or more sensors 134a, 134b, 134c, 134d, 134e, 134f, 134g, 134h, 134i, 134j, 134k may be excluded or may be given an alternative location or locations. For some embodiments, additional sensors may be added.

With reference to FIG. 4, a third embodiment of the gas turbine power generation plant 300 according to the first aspect of the invention is schematically illustrated. For some embodiments, the second water fluid injector unit 136b may be configured to inject water fluid into the air stream 130 downstream of the compressor unit 126a; 126b and upstream of the combustor 114. For some embodiments, it may be defined that the second water fluid injector unit 136b is configured to inject water fluid into the air stream 130 downstream of the air outlet 148 of the compressor unit 126a; 126b and upstream of the combustor 114.

With reference to FIG. 4, for some embodiments, the second water fluid injector unit 136b may include one or more of the group of:
a third water liquid injector 140c for injecting water liquid into the air stream 130 downstream of the compressor unit 126a; 126b and upstream of the combustor 114, wherein the control arrangement 138 may be configured to control the rate of the water liquid injection of the third water liquid injector 140c to regulate the varying physical quantity to the target based on the value of the varying physical quantity determined by the sensor 134a; and
a third water vapour, or steam, injector 142c for injecting water vapour into the air stream 130 downstream of the compressor unit 126a; 126b and upstream of the combustor 114, wherein the control arrangement 138 may be configured to control the rate of the water vapour injection of the third water vapour injector 142c to regulate the varying physical quantity to the target based on the value of the varying physical quantity determined by the sensor 134a.

With reference to FIG. 4, for some embodiments, the gas turbine power generation plant 300 may include a second air, or air stream, cooler 143. For some embodiments, the second water fluid injector unit 136b may be placed in the second air cooler 143. For some embodiments, the second water fluid injector unit 136b is configured to inject the water fluid in the second air cooler 143 and into the air stream 130 upstream of the combustor 114. The second air cooler 143 may be located downstream of the compressor unit 126a; 126b. For some embodiments, it may be defined that the second air cooler 143 is located downstream of the air outlet 148 of the compressor unit 126a; 126b and upstream of the combustor 114.

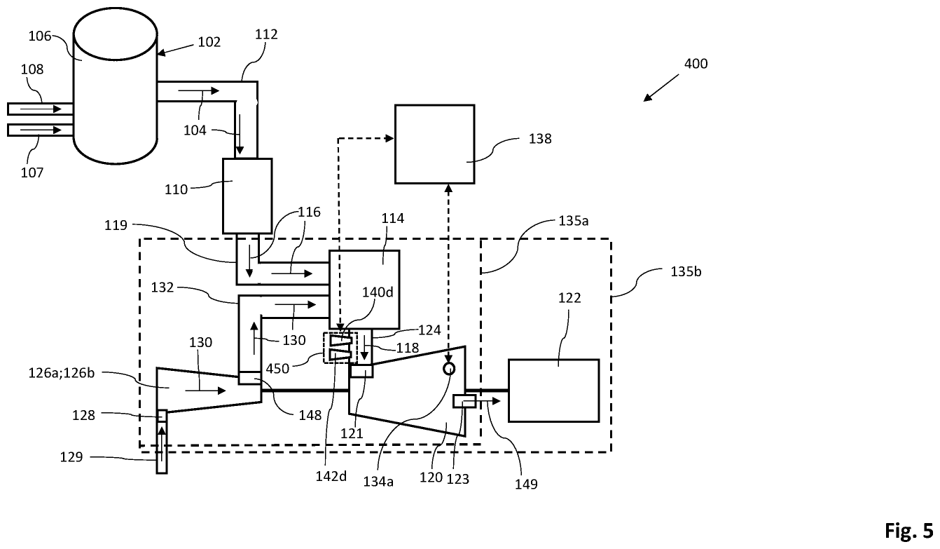

With reference to FIG. 5, a fourth embodiment of the gas turbine power generation plant 400 according to the first aspect of the invention is schematically illustrated. For some embodiments, the gas turbine power generation plant 400 may include a third water fluid injector unit 450 for injecting water fluid into the flue gas stream 118 downstream of the combustor 114 and upstream of the gas expander unit 120, wherein the control arrangement 138 may be configured to control the rate of the water fluid injection of the third water fluid injector unit 450 to regulate the varying physical quantity to the target based on the value of the varying physical quantity determined by the sensor 134a.

With reference to FIG. 5, the third water fluid injector unit 450 may include one or more of the group of:
a fourth water liquid injector 140d for injecting water liquid into the flue gas stream 118 downstream of the combustor 114 and upstream of the gas expander unit 120, wherein the control arrangement 138 may be configured to control the rate of the water liquid injection of the fourth water liquid injector 140d to regulate the varying physical quantity to the target based on the value of the varying physical quantity determined by the sensor 134a; and
a fourth water vapour, or steam, injector 142d for injecting water vapour into the flue gas stream 118 downstream of the combustor 114 and upstream of the gas expander unit 120, wherein the control arrangement 138 may be configured to control the rate of the water vapour injection of the fourth water vapour injector 142d to regulate the varying physical quantity to the target based on the value of the varying physical quantity determined by the sensor 134a.

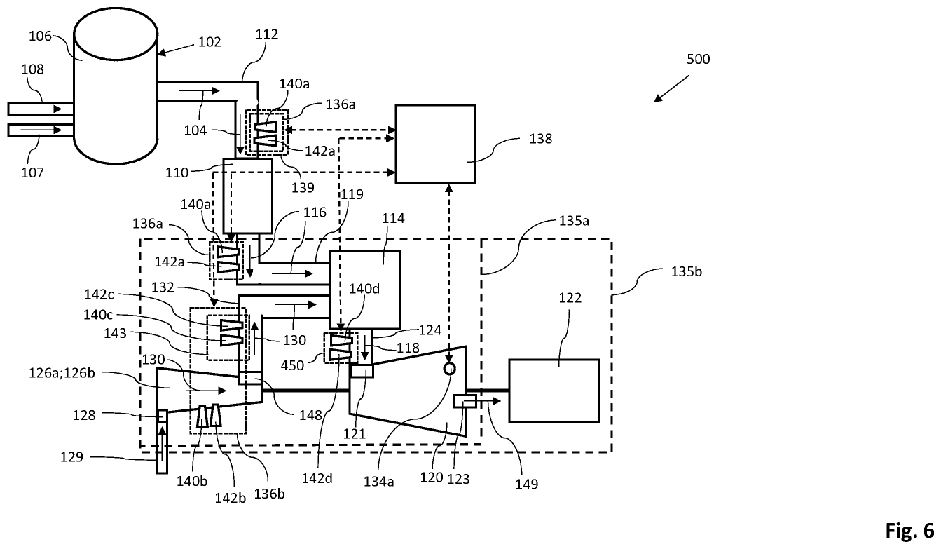

With reference to FIG. 6, a fifth embodiment of the gas turbine power generation plant 500 according to the first aspect of the invention is schematically illustrated. The gas turbine power generation plant 500 illustrated in FIG. 6 is a combination of the first, second, third and fourth embodiments disclosed above. Thus, the gas turbine power generation plant 500 includes the first, second and third water fluid injector units 136a, 136b, 450, the water liquid injectors 140a, 140b, 140c, 140d and the water vapour injectors 142a, 142b, 142c, 142d.

With reference to FIGS. 1A to 6, it is to be understood that for some embodiments, one or more of the one or more water fluid injector units 136a, 136b, 450, 658, 662, one or more of the water liquid injectors 140a, 140b, 140c, 140d, 140e, 140f and/or one or more of the water vapour injectors 142a, 142b, 142c, 142d, 142e, 142f may be excluded without departing from the scope of the power generation plant 100, 200, 300, 400, 500, 600 according to the first aspect or from the scope of the method according to the second aspect.

With reference to FIGS. 1A to 6, one or more of the one or more water fluid injector units 136a, 136b, 450, 658, 662 one or more of the water liquid injectors 140a, 140b, 140c, 140d, 140e, 140f and/or one or more of the water vapour injectors 142a, 142b, 142c, 142d, 142e, 142f may be fluidly connected to one or more of the group of: a water fluid supply 152; a water liquid supply 154; and a water vapour supply 156. This is schematically illustrated in FIG. 1A. The supply 152, 154, 156 may comprise one or more containers holding a water fluid, for example a water liquid and/or a water vapour. For some embodiments, one or more of the water fluid supply 152, water liquid supply 154 and water vapour supply 156 may be supplied by and may be connected to one or more of a steam generator and condenser. The condenser may be a flue gas condenser. The steam generator may be arranged for heat recovery in the flue gas stream downstream of the gas expander unit 120. The condenser may be positioned for water recovery in the flue gas stream downstream of the gas expander unit 120. The condenser may have a connection for water supply to the steam generator.

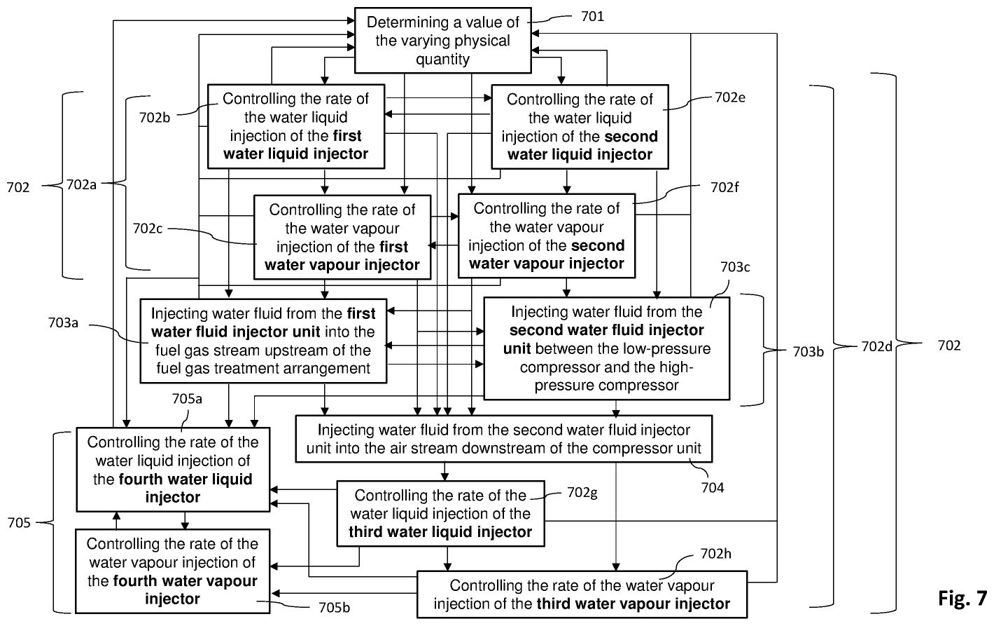

With reference to FIG. 7, aspects of embodiments of the method for regulating a varying physical quantity of a gas turbine power generation plant 100, 200, 300, 400, 500, 600 are schematically illustrated in a flow chart, wherein the gas turbine power generation plant 100, 200, 300, 400, 500, 600 comprises
a solid fuel gasifier 102 for producing a fuel gas stream 104,
a fuel gas treatment arrangement 110 for treating the fuel gas of the fuel gas stream 104,
a combustor 114 for receiving the treated fuel gas stream 116 and for producing a flue gas stream 118,
a gas expander unit 120 for receiving the flue gas stream 118, the gas expander unit 120 being configured to be mechanically coupled to an electric generator 122,
a compressor unit 126a, 126b for supplying air to one or more of the combustor 114, solid fuel gasifier 102 and gas expander unit (120),
wherein the compressor unit 126a, 126b has an air inlet 128,
wherein one or more of the combustor 114, solid fuel gasifier 102 and gas expander unit (120) is/are configured to receive an air stream 130 from the compressor unit 126a, 126b,
wherein the gas turbine power generation plant 100; 200; 300; 400; 500; 600 further comprises
one or more sensors 134a, 134b, 134c, 134d, 134e, 134f, 134g, 134h, 134i, 134j, 134k for determining a value of the varying physical quantity of the gas turbine power generation plant 100, 200, 300, 400, 500, and
one or more water fluid injector units 136a, 136b for injecting water fluid into one or more of the air stream 130 and the fuel gas stream 104, 116. The method comprises:
determining 701, by usage of the sensor 134a, 134b, 134c, 134d, 134e, 134f, 134g, 134h, 134i, 134j, 134k, a value of the varying physical quantity of the gas turbine power generation plant 100, 200, 300, 400, 500, 600; and
controlling 702 the rate of the water fluid injection of the one or more water fluid injector units 136a, 136b to regulate the varying physical quantity to a target based on the determined value of the varying physical quantity.

With reference to FIG. 7, for some embodiments, the method comprises:
controlling 702a the rate of the water fluid injection of the first water fluid injector unit 136a into the fuel gas stream 104, 116 downstream of the solid fuel gasifier 102 and upstream of the combustor 114 in order to regulate the varying physical quantity to the target based on the determined value of the varying physical quantity. For some embodiments, the method comprises: injecting 703a water fluid from the first water fluid injector unit 136a into the fuel gas stream 104 upstream of the fuel gas treatment arrangement 110.

With reference to FIG. 7, for some embodiments, the method comprises controlling 702b the rate of the water liquid injection of the first water liquid injector 140a into the fuel gas stream 104, 116 downstream of the solid fuel gasifier 102 and upstream of the combustor 114 in order to regulate the varying physical quantity to the target based on the determined value of the varying physical quantity. For some embodiments, the method comprises controlling 702c the rate of the water vapour injection of the first water vapour injector 142a into the fuel gas stream 104, 116 downstream of the solid fuel gasifier 102 and upstream of the combustor 114 in order to regulate the varying physical quantity to the target based on the determined value of the varying physical quantity.

With reference to FIG. 7, for some embodiments, the method comprises:
controlling 702d the rate of the water fluid injection of the second water fluid injector unit 136b into the air stream 130 downstream of the air inlet 128 of the compressor unit 126a, 126b, and for some embodiments, upstream of the combustor 114, in order to regulate the varying physical quantity to the target based on the determined value of the varying physical quantity.

With reference to FIG. 7, for some embodiments, the method comprises controlling 702e the rate of the water liquid injection of the second water liquid injector 140b into the air stream 130 downstream of the air inlet 128 of the compressor unit 126a, 126b and upstream of the air outlet 148 of the compressor unit 126a, 126b in order to regulate the varying physical quantity to the target based on the determined value of the varying physical quantity. For some embodiments, the method comprises controlling 702f the rate of the water vapour injection of the second water vapour injector 142b into the air stream 130 downstream of the air inlet 128 of the compressor unit 126a, 126b and upstream of the air outlet 148 of the compressor unit 126a, 126b in order to regulate the varying physical quantity to the target based on the determined value of the varying physical quantity.

With reference to FIG. 7, for some embodiments, the method comprises injecting 703b water fluid from the second water fluid injector unit 126b into the air stream 130 downstream of the air inlet 128 of the compressor unit 126a, 126b and upstream of the air outlet 148 of the compressor unit 126a, 126b. For some embodiments, the method comprises injecting 703c water fluid from the second water fluid injector unit 136b into the air stream 130 between the low-pressure compressor 144 and the high-pressure compressor 146. For example, the method may comprise injecting 703c water fluid from the second water fluid injector unit 136b into the air stream 130 downstream of the low-pressure compressor 144 and upstream of the high-pressure compressor 146.

With reference to FIG. 7, for some embodiments, the method comprises:
injecting 704 water fluid from the second water fluid injector unit 136b into the air stream 130 downstream of the compressor unit 126a, 126b, and for example upstream of the combustor 114. For some embodiments, it may be defined that the method comprises injecting 704 water fluid from the second water fluid injector unit 136b into the air stream 130 downstream of an air outlet 148 of the compressor unit 126a, 126b and upstream of the combustor 114.

With reference to FIG. 7, for some embodiments, the method comprises controlling 702g the rate of the water liquid injection of the third water liquid injector 140c into the air stream 130 downstream of the compressor unit 126a, 126b and upstream of the combustor 114 in order to regulate the varying physical quantity to the target based on the determined value of the varying physical quantity. For some embodiments, the method comprises controlling 702h the rate of the water vapour injection of the third water vapour injector 142c into the air stream 130 downstream of the compressor unit 126a, 126b and upstream of the combustor 114 in order to regulate the varying physical quantity to the target based on the determined value of the varying physical quantity.

With reference to FIG. 7, for some embodiments, the method comprises:
controlling 705 the rate of the water fluid injection of the third water fluid injector unit 450 into the flue gas stream 118 downstream of the combustor 114 and upstream of the gas expander unit 120 in order to regulate the varying physical quantity to the target based on the value of the varying physical quantity determined by the sensor 134a, 134b, 134c, 134d, 134e, 134f, 134g, 134h, 134i, 134j, 134k.

With reference to FIG. 7, for some embodiments, the method comprises controlling 705a the rate of the water liquid injection of the fourth water liquid injector 140d into the flue gas stream 118 downstream of the combustor 114 and upstream of the gas expander unit 120 in order to regulate the varying physical quantity to the target based on the determined value of the varying physical quantity. For some embodiments, the method comprises controlling 705b the rate of the water vapour injection of the fourth water vapour injector 142d into the flue gas stream 118 downstream of the combustor 114 and upstream of the gas expander unit 120 in order to regulate the varying physical quantity to the target based on the determined value of the varying physical quantity.

Unless disclosed otherwise, it should be noted that the method or procedure steps illustrated in FIG. 7 and described herein do not necessarily have to be executed in the order illustrated in FIG. 7. The steps may essentially be executed in any suitable order. Further, for some embodiments, one or more steps may be added to the method without departing from the scope of the appended claims. For some embodiments, one or more steps illustrated in FIG. 7 may be excluded from the method without departing from the scope of the appended claims.

With reference to FIGS. 1A to 7, the varying physical quantity may comprise any one of the group of:
a condition of the fuel gas treatment arrangement 110;
a calorific value of the treated fuel gas of the treated fuel gas stream 116 received by the combustor 114;
the composition of the treated fuel gas of the treated fuel gas stream 116 received by the combustor 114;
a combustion condition of the combustor 114;
a combustion outlet condition of the flue gas of the flue gas stream 118 exiting the combustor 114;
a combustion inlet condition of the air of the air stream 130 entering the combustor 114;
a combustion inlet condition of the treated fuel gas of the treated fuel gas stream 116 entering the combustor 114;
reactivity of the treated fuel gas of the treated fuel gas stream 116 entering the combustor 114;
H₂ content of the treated fuel gas of the treated fuel gas stream 116 entering the combustor 114;
a gas expander unit inlet condition of the flue gas of the flue gas stream 118 entering the gas expander unit 120;
a gas expander unit outlet condition of the flue gas of the flue gas stream 149 exiting the gas expander unit 120;
a gas expander unit outlet composition of the flue gas of the flue gas stream 149 exiting the gas expander unit 120;
a power output of the gas expander unit 120;
an outlet condition of the compressor unit 126a, 126b:
a condition of any stage within the compressor unit 126a, 126b; and
a condition of any stage within the gas expander unit 120.

With reference to FIGS. 1A to 7, the condition of the fuel gas treatment arrangement 110 may comprise a fuel gas treatment temperature.

With reference to FIGS. 1A to 7, the combustion condition of the combustor 114 may comprise any one of the group of:
combustion temperature;
oxygen content;
an emission content;
CO;
unburned hydrocarbons, UHC;
nitrogen oxides;
a pressure difference between the pressure of the gas of the combustor 114 and the pressure of the treated fuel gas upstream of the combustor 114; and
flame instability.

For some embodiments, flame instability may be determined by way of a dynamic pressure signal or an optical signal indicating the flame quality.

With reference to FIGS. 1A to 7, the combustion outlet condition of the flue gas of the flue gas stream 118 exiting the combustor 114 may comprise any one of the group of:
a temperature of the flue gas of the flue gas stream 118 exiting the combustor 114;
oxygen content of the flue gas of the flue gas stream 118 exiting the combustor 114;
unburned hydrocarbons, UHC;
nitrogen oxides;
the composition of the flue gas of the flue gas stream 118 exiting the combustor 114;
CO₂ content of the flue gas of the flue gas stream 118 exiting the combustor 114;
CO content of the flue gas of the flue gas stream 118 exiting the combustor 114; and
nitrogen oxides (NOₓ) content of the flue gas of the flue gas stream 118 exiting the combustor 114.

With reference to FIGS. 1A to 7, the gas expander unit inlet condition of the flue gas of the flue gas stream 118 entering the gas expander unit 120 may comprise any one of the group of:
a temperature of the flue gas of the flue gas stream 118 entering the gas expander unit 120;
a pressure of the flue gas of the flue gas stream 118 entering the gas expander unit 120; and
a flow rate of the flue gas of the flue gas stream 118 entering the gas expander unit 120.

With reference to FIGS. 1A to 7, the gas expander unit outlet condition of the flue gas of the flue gas stream 149 exiting the gas expander unit 120 may comprise any one of the group of:
a temperature of the flue gas of the flue gas stream 149 exiting the gas expander unit 120;
a pressure of the flue gas of the flue gas stream 149 exiting the gas expander unit 120;
a flow rate of the flue gas of the flue gas stream 149 exiting the gas expander unit 120;
the composition of the flue gas of the flue gas stream 149 exiting the gas expander unit 120;
CO₂ content of the flue gas of the flue gas stream 149 exiting the gas expander unit 120;
oxygen content of the flue gas of the flue gas stream 149 exiting the gas expander unit 120;
CO content of the flue gas of the flue gas stream 149 exiting the gas expander unit 120;
unburned hydrocarbons, UHC; and
nitrogen oxides content of the flue gas of the flue gas stream 149 exiting the gas expander unit 120.

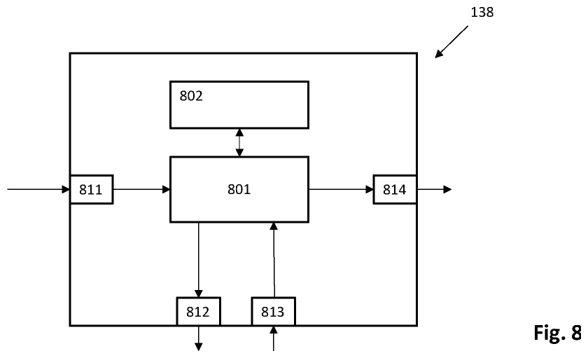

With reference to FIG. 8, a version of the control arrangement 138 of embodiments of the gas turbine power generation plant 100, 200, 300, 400, 500 according to the first aspect of the invention is schematically illustrated. The control arrangement 138 may comprise a computing unit 801, which can be constituted by essentially any suitable type of processor or microcomputer, for example a circuit for digital signal processing (Digital Signal Processor, DSP), or a circuit having a predetermined specific function (Application Specific Integrated Circuit, ASIC). The computing unit 801 is coupled, or electrically connected, to a memory unit 802 arranged in the control arrangement 138. The memory unit 802 provides the computing unit 801 with, for example, the stored program code and/or the stored data which the computing unit 801 requires to be able to perform computations. The computing unit 801 is also arranged to store partial or final results of computations in the memory unit 802.

With reference to FIG. 8, in addition, the control arrangement 138 may be provided with devices 811, 812, 813, 814 for receiving and transmitting input and output signals. These input and output signals can contain waveforms, impulses, or other attributes which, by means of the devices 811, 813 for the reception of input signals, can be detected as information and can be converted into signals which can be processed by the computing unit 801. These signals are then made available to the computing unit 801. The devices 812, 814 for the transmission of output signals are arranged to convert signals received from the computing unit 801 in order to create output signals by, for example, modulating the signals, which can be transmitted to other units or apparatuses of the the gas turbine power generation plant 100, 200, 300, 400, 500. The devices 811, 813 for the reception of input signals may be configured to receive input signals from the one or more sensors 134a, 134b, 134c, 134d, 134e, 134f, 134g, 134h, 134i, 134j, 134k disclosed above. The devices 812, 814 for the transmission of output signals may be configured to transmit output signals to the one or more one or more water fluid injector units 136a, 136b, 450 disclosed above.

The person skilled in the art will appreciate that the herein described embodiments of the method according to the second aspect may be implemented in a computer program, which, when it is executed in a computer, instructs the computer to execute the method. The computer program is usually constituted by a computer program product stored on a non-transitory/non-volatile digital storage medium, in which the computer program is incorporated in the computer-readable medium of the computer program product. The computer-readable medium comprises a suitable memory, such as, for example: ROM (Read-Only Memory), PROM (Programmable Read-Only Memory), EPROM (Erasable PROM), Flash memory, EEPROM (Electrically Erasable PROM), a hard disk unit, etc.

The features of the different embodiments of the gas turbine power generation plant 100, 200, 300, 400, 500 and the method disclosed above may be combined in various possible ways providing further advantageous embodiments.

The present invention is not limited to the above-described embodiments. Instead, the present invention relates to, and encompasses all different embodiments being included within the scope of the independent claims.

1. A gas turbine power generation plant comprising
a solid fuel gasifier for producing a fuel gas stream,
a fuel gas treatment arrangement for treating the fuel gas of the fuel gas stream,
a combustor for receiving the treated fuel gas stream and for producing a flue gas stream,
a gas expander unit for receiving the flue gas stream, the gas expander unit being configured to be mechanically coupled to an electric generator, and
a compressor unit for supplying air to one or more of the combustor, solid fuel gasifier and gas expander unit,
wherein the compressor unit has an air inlet,
wherein one or more of the combustor, solid fuel gasifier and gas expander unit is/are configured to receive an air stream from the compressor unit,
wherein the gas turbine power generation plant further comprises
one or more sensors for determining a value of a varying physical quantity of the gas turbine power generation plant,
one or more water fluid injector units for injecting water fluid into one or more of the air stream and the fuel gas stream, and
a control arrangement for regulating the varying physical quantity of the gas turbine power generation plant,
wherein the control arrangement is configured to control the rate of the water fluid injection of the one or more water fluid injector units to regulate the varying physical quantity to a target based on the value of the varying physical quantity determined by the sensor.

2. A gas turbine power generation plant according to claim 1, wherein the one or more water fluid injector units comprises/comprise a first water fluid injector unit for injecting water fluid into the fuel gas stream downstream of the solid fuel gasifier and upstream of the combustor, and
wherein the control arrangement is configured to control the rate of the water fluid injection of the first water fluid injector unit to regulate the varying physical quantity to the target based on the value of the varying physical quantity determined by the sensor.

3. A gas turbine power generation plant according to claim 2, wherein the first water fluid injector unit is configured to inject water fluid into the fuel gas stream upstream of the fuel gas treatment arrangement.

4. A gas turbine power generation plant according to claim 2, wherein the first water fluid injector unit comprises one or more of the group of:
a first water liquid injector for injecting water liquid into the fuel gas stream downstream of the solid fuel gasifier and upstream of the combustor, wherein the control arrangement is configured to control the rate of the water liquid injection of the first water liquid injector to regulate the varying physical quantity to the target based on the value of the varying physical quantity determined by the sensor; and
a first water vapour injector for injecting water vapour into the fuel gas stream downstream of the solid fuel gasifier and upstream of the combustor, wherein the control arrangement is configured to control the rate of the water vapour injection of the first water vapour injector to regulate the varying physical quantity to the target based on the value of the varying physical quantity determined by the sensor.

5. A gas turbine power generation plant according to claim 1, wherein the one or more water fluid injector units comprises/comprise a second water fluid injector unit for injecting water fluid into the air stream downstream of the air inlet of the compressor unit and upstream of the combustor, and
wherein the control arrangement is configured to control the rate of the water fluid injection of the second water fluid injector unit to regulate the varying physical quantity to the target based on the value of the varying physical quantity determined by the sensor.

6. A gas turbine power generation plant according to claim 5, wherein the compressor unit comprises an air outlet,
wherein one or more of the combustor, solid fuel gasifier and gas expander unit is/are configured to receive an air stream from the air outlet of the compressor unit, and
wherein the second water fluid injector unit is configured to inject water fluid into the air stream downstream of the air inlet of the compressor unit and upstream of the air outlet of the compressor unit.

7. A gas turbine power generation plant according to claim 5, wherein the compressor unit comprises a low-pressure compressor and a high-pressure compressor, and
wherein the second water fluid injector unit is configured to inject water fluid into the air stream between the low-pressure compressor and the high-pressure compressor.

8. A gas turbine power generation plant according to claim 7, wherein the second water fluid injector unit is configured to inject water fluid into the air stream downstream of the low-pressure compressor and upstream of the high-pressure compressor.

9. A gas turbine power generation plant according to claim 5, wherein the second water fluid injector unit comprises one or more of the group of:
a second water liquid injector for injecting water liquid into the air stream downstream of the air inlet of the compressor unit and upstream of the air outlet of the compressor unit, wherein the control arrangement is configured to control the rate of the water liquid injection of the second water liquid injector to regulate the varying physical quantity to the target based on the value of the varying physical quantity determined by the sensor; and
a second water vapour injector for injecting water vapour into the air stream downstream of the air inlet of the compressor unit and upstream of the air outlet of the compressor unit, wherein the control arrangement is configured to control the rate of the water vapour injection of the second water vapour injector to regulate the varying physical quantity to the target based on the value of the varying physical quantity determined by the sensor.

10. A gas turbine power generation plant according to claim 5, wherein the second water fluid injector unit is configured to inject water fluid into the air stream downstream of the compressor unit and upstream of one or more of the combustor, solid fuel gasifier and gas expander unit.

11. A gas turbine power generation plant according to claim 10, wherein the second water fluid injector unit comprises one or more of the group of:
a third water liquid injector for injecting water liquid into the air stream downstream of the compressor unit and upstream of the combustor, wherein the control arrangement is configured to control the rate of the water liquid injection of the third water liquid injector to regulate the varying physical quantity to the target based on the value of the varying physical quantity determined by the sensor; and
a third water vapour injector for injecting water vapour into the air stream downstream of the compressor unit and upstream of the combustor, wherein the control arrangement is configured to control the rate of the water vapour injection of the third water vapour injector to regulate the varying physical quantity to the target based on the value of the varying physical quantity determined by the sensor.

12. A gas turbine power generation plant according to claim 1, wherein the gas turbine power generation plant comprises a third water fluid injector unit for injecting water fluid into the flue gas stream downstream of the combustor and upstream of the gas expander unit, and
wherein the control arrangement is configured to control the rate of the water fluid injection of the third water fluid injector unit to regulate the varying physical quantity to the target based on the value of the varying physical quantity determined by the sensor.

13. A gas turbine power generation plant according to claim 12, wherein the third water fluid injector unit comprises one or more of the group of:
a fourth water liquid injector for injecting water liquid into the flue gas stream downstream of the combustor and upstream of the gas expander unit, wherein the control arrangement is configured to control the rate of the water liquid injection of the fourth water liquid injector to regulate the varying physical quantity to the target based on the value of the varying physical quantity determined by the sensor; and
a fourth water vapour injector for injecting water vapour into the flue gas stream downstream of the combustor and upstream of the gas expander unit, wherein the control arrangement is configured to control the rate of the water vapour injection of the fourth water vapour injector to regulate the varying physical quantity to the target based on the value of the varying physical quantity determined by the sensor.

14. A gas turbine power generation plant according to claim 1, wherein the varying physical quantity comprises any one of the group of:
a condition of the fuel gas treatment arrangement;
a calorific value of the treated fuel gas of the treated fuel gas stream received by the combustor;
the composition of the treated fuel gas of the treated fuel gas stream received by the combustor;
a combustion condition of the combustor;
a combustion outlet condition of the flue gas of the flue gas stream exiting the combustor;
a combustion inlet condition of the air of the air stream entering the combustor;
a combustion inlet condition of the treated fuel gas of the treated fuel gas stream entering the combustor;
reactivity of the treated fuel gas of the treated fuel gas stream entering the combustor;
H₂ content of the treated fuel gas of the treated fuel gas stream entering the combustor;
a gas expander unit inlet condition of the flue gas of the flue gas stream entering the gas expander unit;
a gas expander unit outlet condition of the flue gas of the flue gas stream exiting the gas expander unit;
a gas expander unit outlet composition of the flue gas of the flue gas stream exiting the gas expander unit;
a power output of the gas expander unit;
an outlet condition of the compressor unit:
a condition of any stage within the compressor unit; and
a condition of any stage within the gas expander unit.

15. (canceled)

16. A gas turbine power generation plant according to claim 14, wherein the combustion condition of the combustor comprises any one of the group of:
combustion temperature;
oxygen content;
an emission content;
CO;
unburned hydrocarbons, UHC;
nitrogen oxides;
a pressure difference between the pressure of the gas of the combustor and the pressure of the treated fuel gas upstream of the combustor; and
flame instability.

17. A gas turbine power generation plant according to claim 14, wherein the combustion outlet condition of the flue gas of the flue gas stream exiting the combustor comprises any one of the group of:
a temperature of the flue gas of the flue gas stream exiting the combustor;
oxygen content of the flue gas of the flue gas stream exiting the combustor;
unburned hydrocarbons, UHC;
nitrogen oxides;
the composition of the flue gas of the flue gas stream exiting the combustor;
CO₂ content of the flue gas of the flue gas stream exiting the combustor;
CO content of the flue gas of the flue gas stream exiting the combustor; and
nitrogen oxides content of the flue gas of the flue gas stream exiting the combustor.

18-19. (canceled)

20. A method for regulating a varying physical quantity of a gas turbine power generation plant, the gas turbine power generation plant comprising
a solid fuel gasifier for producing a fuel gas stream,
a fuel gas treatment arrangement for treating the fuel gas of the fuel gas stream,
a combustor for receiving the treated fuel gas stream and for producing a flue gas stream,
a gas expander unit for receiving the flue gas stream, the gas expander unit being configured to be mechanically coupled to an electric generator, and
a compressor unit for supplying air to one or more of the combustor, solid fuel gasifier and gas expander unit,
wherein the compressor unit has an air inlet,
wherein one or more of the combustor, solid fuel gasifier and gas expander unit is/are configured to receive an air stream from the compressor unit,
wherein the gas turbine power generation plant further comprises
one or more sensors for determining a value of the varying physical quantity of the gas turbine power generation plant, and
one or more water fluid injector units for injecting water fluid into one or more of the air stream and the fuel gas stream,
wherein the method comprises:
determining, by usage of the sensor, a value of the varying physical quantity of the gas turbine power generation plant; and
controlling the rate of the water fluid injection of the one or more water fluid injector units to regulate the varying physical quantity to a target based on the determined value of the varying physical quantity.

21. A method according to claim 20, wherein the one or more water fluid injector units comprises/comprise a first water fluid injector unit for injecting water fluid into the fuel gas stream downstream of the solid fuel gasifier and upstream of the combustor, and
wherein the method comprises:
controlling the rate of the water fluid injection of the first water fluid injector unit to regulate the varying physical quantity to the target based on the determined value of the varying physical quantity.

22. A method according to claim 21, wherein the method comprises:
injecting water fluid from the first water fluid injector unit into the fuel gas stream upstream of the fuel gas treatment arrangement.

23. A method according to claim 21, wherein the first water fluid injector unit comprises one or more of the group of:
a first water liquid injector for injecting water liquid into the fuel gas stream downstream of the solid fuel gasifier and upstream of the combustor, wherein the method comprises controlling the rate of the water liquid injection of the first water liquid injector to regulate the varying physical quantity to the target based on the determined value of the varying physical quantity; and
a first water vapour injector for injecting water vapour into the fuel gas stream downstream of the solid fuel gasifier and upstream of the combustor, wherein the method comprises controlling the rate of the water vapour injection of the first water vapour injector to regulate the varying physical quantity to the target based on the determined value of the varying physical quantity.

24-38. (canceled)
